(19) United States
(12) Patent Application Publication
(10) Pub. No.: US 2009/0121829 A1
(43) Pub. Date: May 14, 2009

(54) Method, Electronic Cover, and Access Unit for Providing Access to a Zone by Means of a Card

(75) Inventors: Willi Brandli, Bergdietikon (CH); Gino Burro, Zurich (CH); Peter Kym, Mohlin (CH); Alfred Lauper, Zurich (CH); Stefan Ruegsegger, Winterthur (CH); Olaf Sprich, Aeugst (CH)

Correspondence Address: SIEMENS SCHWEIZ AG;I-47, INTELLECTUAL PROPERTY, ALBISRIEDERSTRASSE 245, ZURICH, CH-8047, CH

(73) Assignee: Siemens Schweiz AG, Zurich (CH)

(21) Appl. No.: 11/922,530

(22) PCT Filed: Mar. 1, 2006
(86) PCT No.: PCT/EP2006/001849

§ 371 Date: Dec. 19, 2007

(30) Foreign Application Priority Data
Jun. 22, 2005 (EP) 05013418.8
Dec. 7, 2005 (EP) 05026691.5

(51) Int. Cl. G05B 19/00

(52) U.S. Cl. 340/5.2

(57) ABSTRACT

An access system includes a portable pouch and an access unit. The pouch has an inserted electronic card, a card receive module and a send/receive module. The access unit is assigned to a transit region of the zone and has a send/receive unit for a communication with the send/receive module of the pouch. To provide access, the tag is transmitted to the send/receive unit of the access unit when the pouch is within range of the send/receive unit. If the tag received by the send/receive unit matches a stored tag, an unblocking signal for providing access to the zone is generated. A signal detector of the pouch detects an electromagnetic field generated by a send unit arranged in the transit region, and information transmitted by the electromagnetic field is processed. A bidirectional communication between the send/receive unit of the access unit and the send/receive module of the pouch is initiated.

### CROSS-REFERENCE TO RELATED APPLICATIONS

The present application is a national stage application of International Application No. PCT/EP2006/001849, filed on Mar. 1, 2006, which claims priority to European Patent Application Nos. 05013418.8, filed on Jun. 22, 2005, and 05026691.5, filed Dec. 7, 2005, which are incorporated herein by reference.

### BACKGROUND OF THE INVENTION

The underlying invention relates to a method, an electronic pouch and an access unit for providing access to a zone by means of a card.

In this patent specification uses the general term “electronic card” to encompass electronic identity cards which are also referred to be terms such as smart card, chip card, electronic ticket, proximity cards, vicinity cards and employee badges and other such cards. Proximity cards and vicinity cards are standardized in accordance with ISO, this is defined in ISO 14443 and ISO 15693.

The terms and definitions specified in the list of abbreviations and acronyms used, in the sense of a glossary, form an integral part of this patent specification. That is why not all the acronyms and terms are specifically introduced. In addition, instead of using non-technical German terminology, the standard English expressions such as, for example, “Timer”, are used for individual units or, in some cases, also specified in two languages in the appendix. In some cases, the function implemented by means of a component is also provided with the same reference symbol as that of the component.

Proximity cards PICC can transmit data to a reader unit PCD within a range of about 1 to 10 cm. Therefore, a person is forced to bring the card into the proximity of the reading unit PCD for providing access to a zone. This is particularly unfavorable when approaching a garage, since it also involves opening the window of the motor vehicle. The risk especially arises during this operation of the card falling onto the ground when being manipulated in this way.

What are known as “Combi-Boosters”, manufactured by N. V. Nederlandsche Apparatenfabriek NEDAP, for example, are used to deal with this problem. A “Booster” is an electronic portable device (=electronic pouch), into which a proximity card is inserted. A tag, mostly called a personal tag referred to as a “personalized” tag hereinafter, is transferred from the proximity card over the radio interface into the pouch. Said pouch sends this received identity on another frequency, for example, on the ISM band of 2.45 GHz to a stationary receive unit. The received tag is evaluated in a background system and, if it matches, an unblocking signal is generated for granting access. The pouch can in such cases likewise contain a further tag, so that access is only possible by means of the relevant pouch and the card. In the sense of this patent specification, a pouch is understood as meaning a portable, electronic device, which can accommodate an electronic card and is provided with means for communication with the card and an external send/receive unit.

Such a system is also desirable for an access control, in which a person carries such a pouch with an inserted electronic card. The aforementioned solution for a car park approach is not satisfactory for the following reasons:
The autonomy is limited or must be operated by an installation in a motor vehicle with wired power supply.
The range is at most statically adjustable. This automatically leads to a detection as soon as such a pouch is in the proximity of a transit region. In this case, proximity is to be understood as a distance in the order of magnitude of between 10 m and 50 m.
Because of the large range, which cannot be adjusted dynamically, a communication with a plurality of such pouches takes place in the proximity of a transit zone. To this end, anti-collision algorithms are to be implemented per se and the throughput of data thus decreases. This problem can partially be solved by the user being able to activate the pouch by means of an activation element provided on the pouch.

### SUMMARY OF THE INVENTION

The underlying object of the present invention is thus to provide a method, an electronic pouch and an access unit for granting access to a zone by means of an electronic card, which on the one hand overcomes the prevalent disadvantages and in addition allows:
high autonomy of the pouch;
a secure function even with a plurality of pouches with inserted cards before a transit zone;
the ability to be used for different types of electronic cards;
simple implementation of a secured transmission, for example also with public key infrastructure, PKI;
simple re-use of existing access units;
simple handling by the user and thereby increased convenience, for example, by a so-called “Handsfree” access.

Accordingly, one aspect involves a method for providing access to a predetermined zone. The method is used in an access system including a portable pouch and an access unit. The pouch has an inserted electronic card, a card receive module and a send/receive module coupled to the card receive module. The electronic card includes at least one tag that is transmitted in a wireless manner from the card to the card receive module. The access unit is assigned to a transit region of the zone and has a send/receive unit configured for a communication with the send/receive module of the pouch. The tag is transmitted to the send/receive unit of the access unit when the pouch is within a predetermined range of the first send/receive unit. The access unit determines if the tag received by the send/receive unit matches a stored tag, and generates an unblocking signal for providing access to the zone if the received tag and the stored tag match. A signal detector of the pouch detects an electromagnetic field generated by a send unit arranged in the transit region, wherein information transmitted by means of the electromagnetic field is processed. The information defines a predetermined minimum receive level necessary for activating electronic components of the pouch. A bidirectional communication between the send/receive unit of the access unit and the send/receive module of the pouch is initiated.

Another aspect involves an electronic portable pouch having a support for attaching a card storing a tag, and a card receive module located on the pouch. The card receive module is configured to receive the tag in a wireless manner when the card s attached. The pouch includes further a send/receive module connected to the card receive module and configured to provide for a bidirectional communication with an access unit for providing access to a zone, and a signal detector configured to detect an electromagnetic field and to activate the send/receive module for bidirectional communication with the access unit. A common loop antenna is provided for receiving the electromagnetic field and for wireless transmission of the tag from the card to the card receive module.

A further aspect involves an access unit for providing access to a zone with an electronic card containing at least one personified tag. The access unit includes a send/receive unit for communication with an electronic pouch containing a card in order that a personified tag is transmitted from the pouch to the send/receive unit. The access unit includes further a card reader and a card load modulation unit connected to the send/receive unit, to that the tag is transmitted by means of a card emulation.

The procedural steps according to the invention mean that the electronic pouch is only activated when required and in this way power consumption is minimized or a high autonomy ensured. The explicit activation by the electromagnetic field means that only the cards at a certain distance in front of the transit zone are activated, so that communication takes place with substantially smaller collisions and for this reason is safer. Bidirectional communication authorizes the exchange of keys so that a cryptology can be implemented in the classical manner.

Furthermore, by means of the previous activation of the pouch, bidirectional communication is likewise also associated with low power consumption seen over a period of time because polling from the pouch or a ready-to-receive state in response to so-called broadcast messages sent by the access unit is dispensed with. In accordance with the content of EP 1 210 693 B1, bi-directional communication can be arranged in an intermittent manner in a time pattern.

Advantageous embodiments of the underlying invention are specified in dependent claims.

In order to increase the autonomy further, provision can be made for the pouch to only be able to carry out a bidirectional communication to the access unit when a card is inserted. As a result it can also be ensured that detection only takes place if the user really wants this in the sense of an active deliberate act and not by the accidental passing by a transit zone. This deliberate act for example manifests itself as pushing a defined control element on the pouch.

The pouch can feature a display for displaying information transmitted about the bidirectional communication. Thus the following information can for example be displayed on the display depending on the application and use:
stored authorizations,
configured user profile,
previous transactions and detections,
remaining balance of a cash function implemented on the card.

With at least one control element arranged on the pouch such as for example a pushbutton or keys on the pouch, the device can be configured and the display controlled. In addition, the control elements can be protected from incorrect manipulations if a defined control element is pushed accidentally on said pouch. This protection can be implemented by software or done mechanically. Likewise, a deliberate act for access to a zone can be undertaken by the user with the control elements.

The bidirectional communication between the pouch and the access unit makes it possible, with a conventional card reader located in the access unit, for the card detached from the access unit to be emulated. As a result, existing access units can continue to be used on the one hand and, on the other hand, the interface between the access unit and the management system need not be disclosed.

### BRIEF DESCRIPTION OF THE SEVERAL VIEWS OF THE DRAWINGS

The invention is described in more detail below with reference to the associated drawings, wherein:

FIG. 1 shows a spatial arrangement of the different functional units in a transit zone;

FIG. 2 shows a block diagram of a pouch and an assigned access unit in a first embodiment;

FIG. 3 shows a block diagram of a pouch and an assigned access unit in a second embodiment;

FIG. 4 shows a block diagram of a pouch and an assigned access unit in a third embodiment with a public key infrastructure;

FIG. 5 is a detailed block diagram of an electronic pouch with a card receive module;

FIG. 6 shows a constructional embodiment of the electronic pouch in various perspective views;

FIG. 7 shows a solution of coupling-in a Legic card in accordance with the prior art; and

FIG. 8 shows a coupling-in a Legic card in accordance with a preferred embodiment.

### DETAILED DESCRIPTION OF THE INVENTION

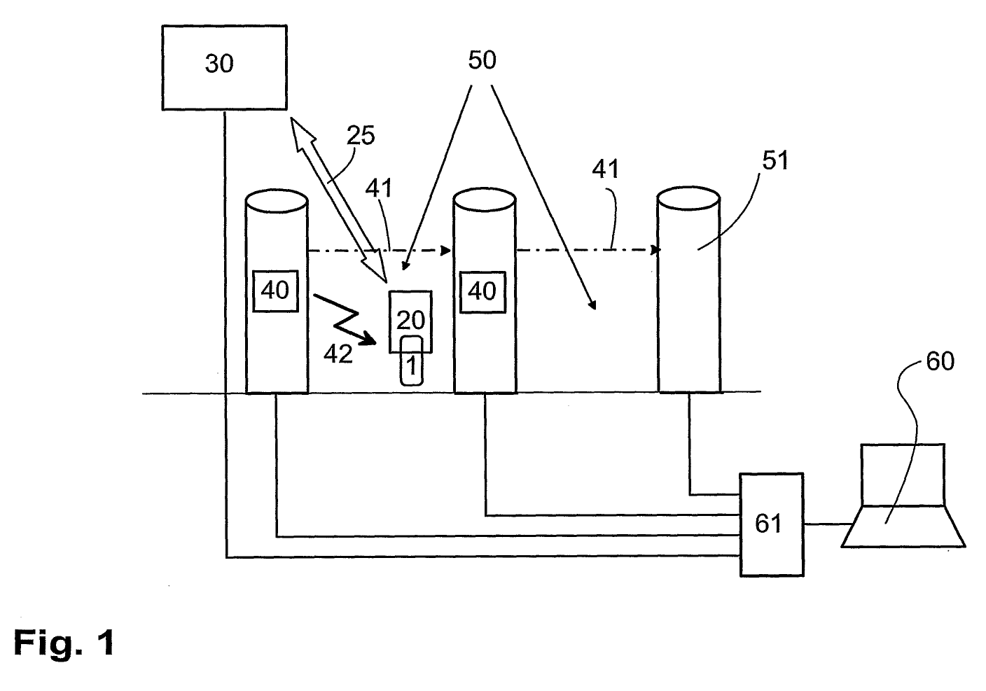

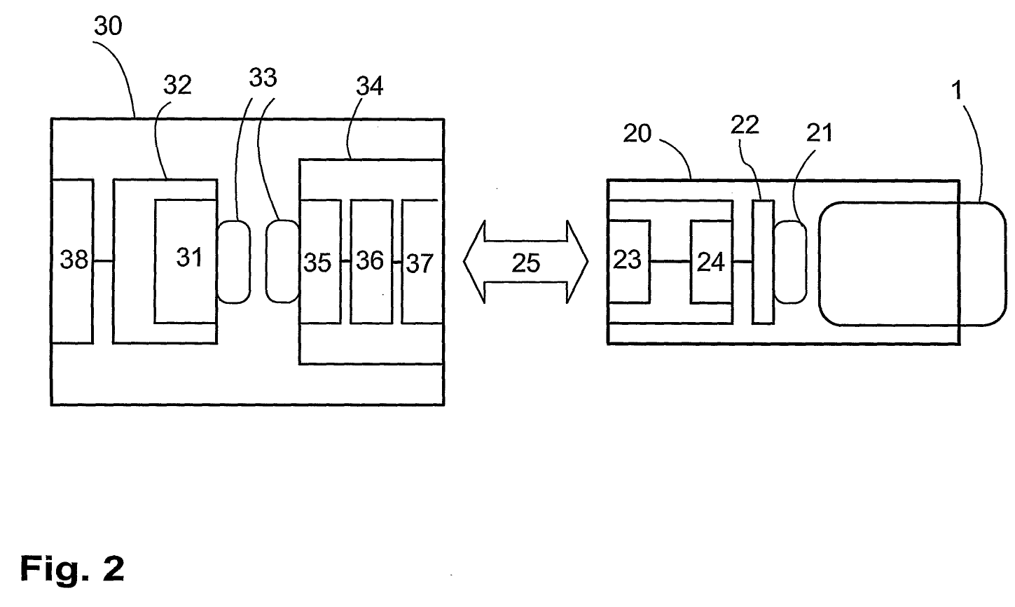

An overview of the basic function of the method in accordance with the invention is given below with reference to FIG. 1. Detailed information about the individual units and their function is shown in the additional FIGS. 2 to 6.

FIG. 1 shows the spatial arrangement of different functional units in a transit zone 50, which is formed by two passage columns 51 in each case. Such a column contains a further send unit 40, which emits an electromagnetic field 42 in the so-short range area, preferably a “low” frequency in the ISM band of for example 6.78 MHz is provided. In order to grant access, the electronic pouch 20 carried by a person is switched to an active state when approaching the transit zone 50. As a result, a bidirectional communication 25 is initiated at a “higher” frequency in the band of preferably 868 MHz. A card 1 is inserted into the pouch 20. By means of the aforementioned bidirectional communication 25, a tag is transmitted from the pouch 20 to an access unit 30. The most personified tag is thereby transmitted in advance wirelessly from the card 1 in the pouch 20. Said tag is supplied from the access unit 30 via an interface unit 61 to a management system 60, in which this tag is evaluated. If the transmitted tag matches a stored tag, an unblocking signal is generated which is supplied to a real barrier or to a virtual barrier arranged in the columns 51. Said barrier, not shown in FIG. 1, is opened by this unblocking signal and in this way makes it possible to access a protected zone. A light signal can also be provided as a virtual barrier. In order to check the actual passage, provision can be made for a light barrier 41. The light barrier shown in FIG. 1 or an additional light barrier or a proximity circuit can activate the send unit 40. In this way, it is additionally ensured that only such pouches as were previously activated accept bidirectional communication 25 with the access unit 30.

For the explanation of the mode of operation of switching to an active state by means of a low frequency of the pouch 20 and bidirectional communication which takes place afterwards, the reader is referred to patent specification EP 1 210 693 B1, in particular to power-saving intermittent bidirectional communication 25 at the higher frequency. The switching to an active state of the pouch, if necessary with different stages by the electromagnetic field sent by the send unit 40, is to be taken from the patent specification WO 03/017207. This patent specification represents an integrating part of this text and herein incorporated by reference.

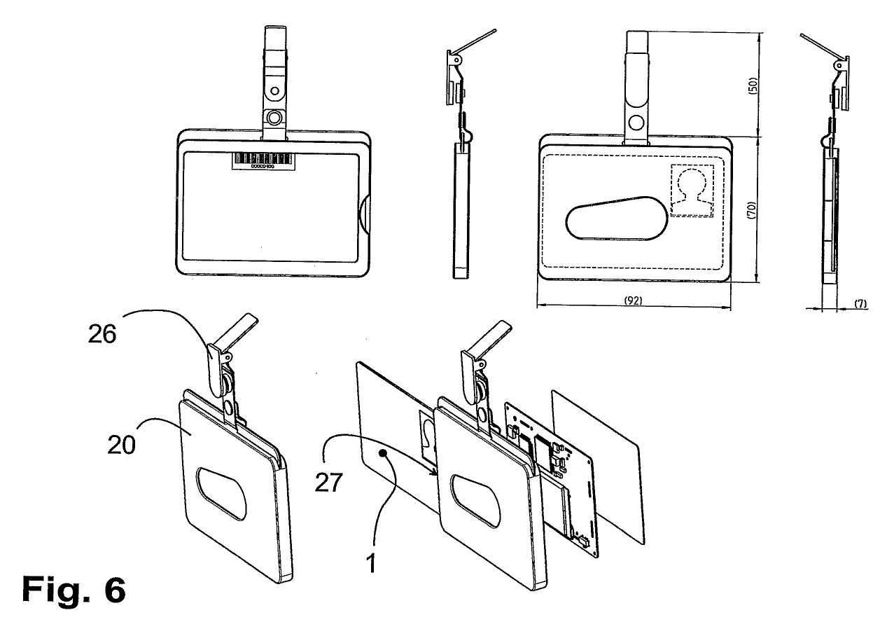

The constructional arrangement of the pouch 20 is shown in FIG. 6 in different perspective views. The pouch 20 is preferably provided with a usual clip 26, so that this pouch can be used in the same way as a card carried in a protective pouch, i.e. can be carried visibly on an article of clothing. In this process, depending on the type of embodiment, the card 1 can then be inserted completely or only partially through the opening 27 into the pouch 1. Moreover, it is possible for the inserted card 1 to be either partially or completely visible on the one side. It is thus not necessary for the visible side to feature yet another transparent element of the pouch 20. At this point it is again pointed out that the transmission is carried out in accordance with the current standards by the card 1 in the pouch 20 via a radio link, in the case of proximity cards for example on a frequency of 13.56 MHz in accordance with ISO/IEC 14443-2. In addition to the communication function in accordance with the underlying invention for the user, the pouch 20 also has a protective function for the card 1 as well as a storage function for the card 1. As a result, a cyclist can for example gain access to a zone by means of a pouch 20 containing a card 1, without a user interaction on the pouch 20 being necessary for this purpose. In this process, the cyclist simply carries this pouch 20 in his backpack.

FIG. 2 shows a simplified block diagram of an electronic pouch 20 and an assigned access unit 30, which are arranged in a transit zone 50. The pouch 20 features a card receive module 22 and an antenna 21, in order to transfer the data of the card, that is, in particular a tag, to the pouch in the usual wireless manner. The component EM4094 from EM Microelectronic, Marin, Switzerland, can for example be used as the card receive module 22. For communication to the access unit, for example on the frequency 868 MHz, a send/receive module 23 is contained in pouch 20 in the sense of patent specification EP 1 210 693 B1. A card interface 24 is arranged between the send/receive module 23 and the card receive module 22, which can optionally be implemented in software or on hardware. This embodiment represents an extension of the radio link, with the fundamental difference from the boosters described in the introduction lying in the fact that the pouch 20 is switched to an active state in the near field by a further send unit 40 arranged in the transit zone 50. In the access unit 30, an emulation of the card interface of the pouch 20 takes place in a communication module 34 via two antennas 33. The communication module 34 contains a send/receive unit 37 in the sense of patent specification EP 1 210 693 B1. An ISO 14443 load modulation 35 is connected via a label emulation 36 to this send/receive unit 37. The “actual” card reader 32 contains a coding module 31, which in technical terminology is often referred to as “Legic security”. This embodiment in accordance with FIG. 2 has the big advantage that because of the above-mentioned communication module 34, the current access units—that is essentially a card reader 32 with an interface unit 38 between the Legic reader and a background access system such as for example SIPORT®—can further be used. Technically speaking, this embodiment results in the emulation of an access card 1, which in actual fact 30 m to 50 m away. The transmission of at least one tag of the card is carried out by means of bidirectional communication 25 in the frequency range of 868 MHz. The frequency specified is only by way of example here and the frequency selection has to comply with the regulatory requirements of the individual countries.

This also applies to the frequency 6.78 MHz for activating the pouch 20.

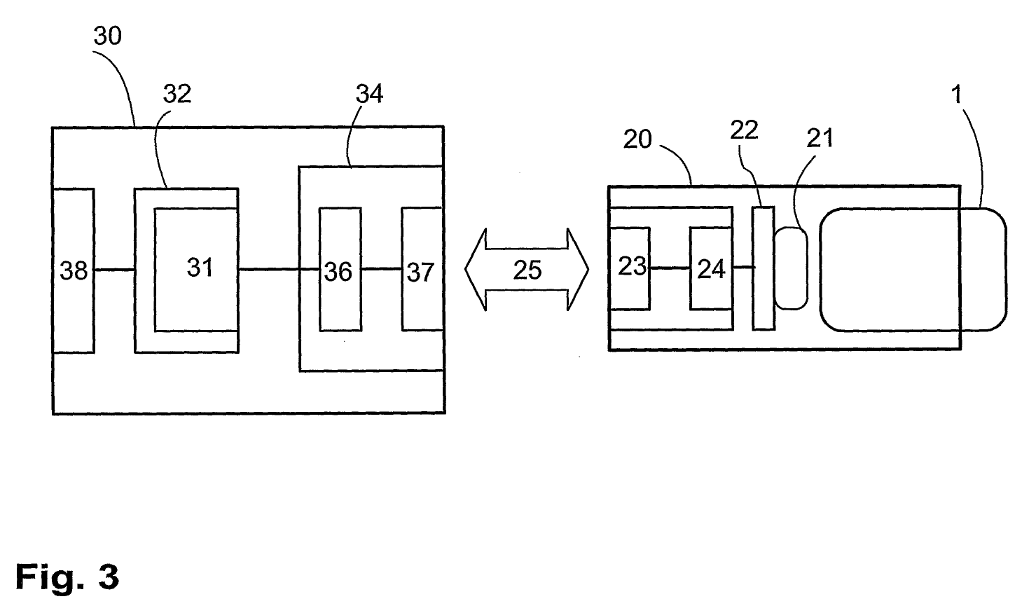

The embodiment in accordance with FIG. 3 differs from that depicted in FIG. 2 through its connection to the access unit 31. The tag transmitted via bidirectional communication 25 is directly supplied by the label emulation 36 via a bus system to the card reader. This embodiment with the same functionality as that of FIG. 2 needs a smaller number of components and is to be used, if for competition policy reasons, no technical restrictions are imposed.

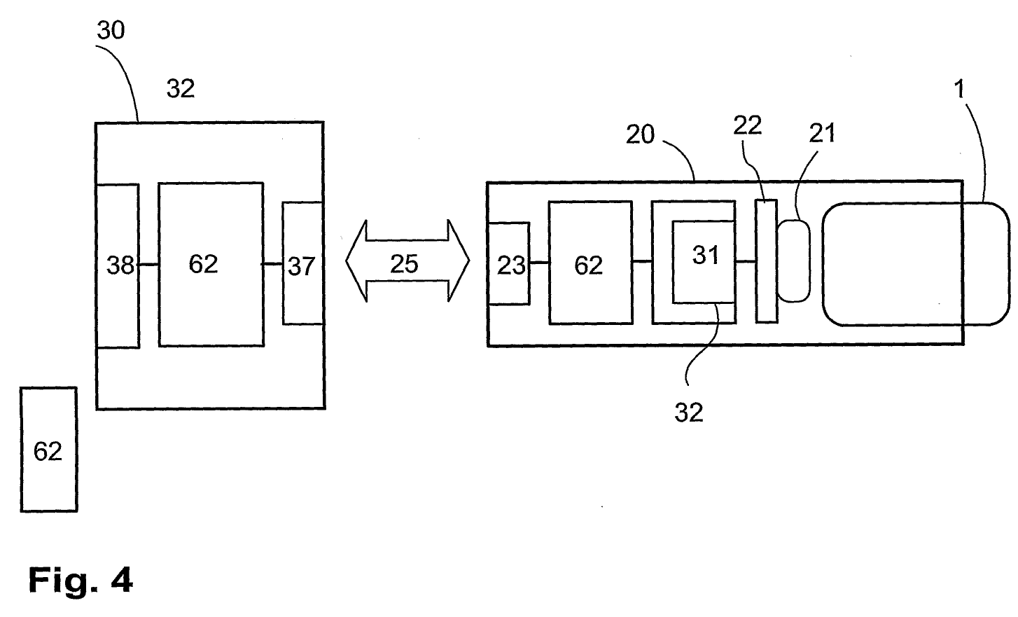

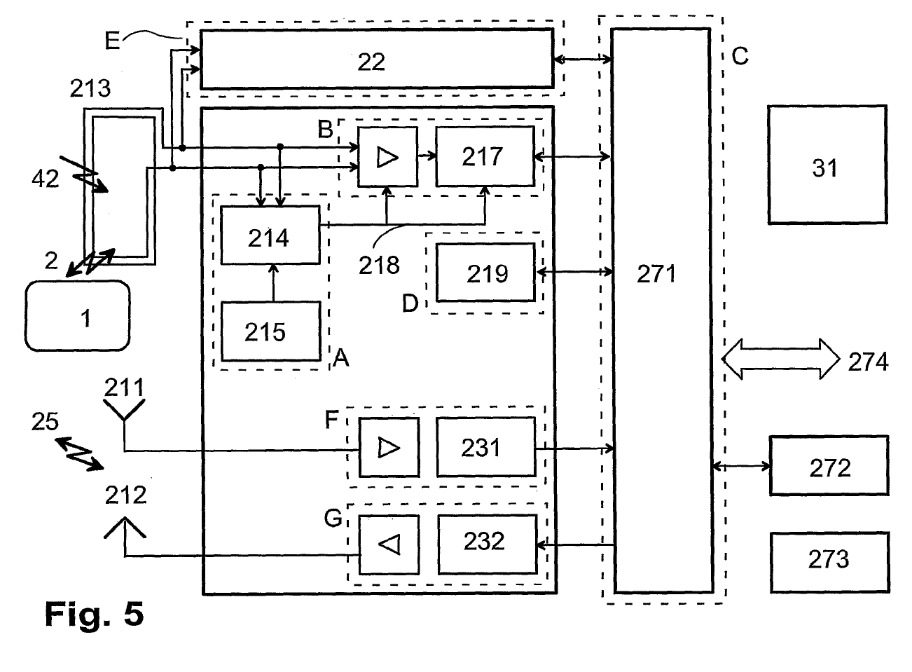

In the case of the embodiment in accordance with FIG. 4, the basic functions of the card reader are incorporated into the pouch 20, in other words: the radio transmission between the card 1 and the card reader 32 terminates in the pouch, by contrast with the embodiments of FIGS. 2 and 3, where this termination takes place remotely in the access unit 30. Bidirectional communication 25 makes it possible to encrypt this using a PKI infrastructure 62. This is in particular necessary if with the suggested method for providing access, a particularly high level of security is to be achieved. This infrastructure 62 is only shown in rudimentary form in FIG. 4, since this belongs to the prior art itself. In FIGS. 2 to 4, the antenna 21 is represented only in principle for the transmission of data, in particular the tag from the card 1 to the pouch 20. A preferred embodiment of the antenna 21 is explained below with reference to FIG. 5.

FIG. 5 shows a detailed block diagram of an electronic pouch with a card receive module for those parts which bring about the switching to an active state of the pouch when approaching an electromagnetic near field. For the receipt of the aforementioned near field in the frequency range of for example 6.78 MHz, provision has been made for a loop antenna 213. “Near field” means that the H-field is dominant. The “near field” or its spatial extent is usually defined with

r<λ0.6 . . . 0.16;

λ [Lambda] stands for the wavelength. Within said short range r, the magnetic field strength H decreases rapidly with the third power of the distance from the transmitter. For this reason, a spatially highly restricted, defined sphere of activity can be implemented. The loop antenna 213 (according to the antenna 21 in the FIGS. 2 to 4) is connected to the signal detector 214 on the one hand and on the other hand to the card receive module 22. As a result of a very small distance between the card 1 and the loop antenna 213, a coupling factor of K z 1 is obtained for the radio link 2. The commercially-available component EM4094 has been specified above for used the card receive module 22. In order to minimize the power consumption of the pouch 20, different functional units are activated only if necessary and in a step-by-step manner. In order to explain the step-by-step activation, these units are combined by means of a dashed line and identified with the letters A, B, C, . . . . The individual letters identify the following situations:
A A signal detector 214 and a clock generator 215 are continuously or intermittently switched to an active state.
B An amplifier and the telegram filter 217 will switch the signal detector 214 to an active state by means of the “filter activation” transmitted over the signal line 218.
C If a telegram (=record on a higher layer) transmitted over the electromagnetic near field was identified as valid for the relevant pouch; the controller 271 is switched to an active state.
D Depending on the result of the evaluations activated by the controller of the timer 219, it, is also possible that the timer 219 for its part activates itself, for example, via a so-called interrupt trigger.
E The card receive module 22 is activated by the controller 271.
F, G Communication on the route 25 will be controlled by the controller (and a ROM-resident program), the receive module 231 on 868 MHz and the send module 232 on 868 MHz can therefore be switched on by the controller 271 as required.

By means of this step-by-step activation of the individual components, the power consumption can be significantly reduced and for this reason the autonomy can be increased accordingly. This likewise represents a considerable difference to the prior art, because the proposed boosters are fitted in a motor vehicle and can accordingly by supplied with power from a car battery. The receive module 231 on 868 MHz and the send module 232 on 868 MHz are each connected to one amplifier with appropriate antennas 211 and 212.

Therefore, the connection between the controller 271 and the telegram filter 217 is, inter alia, bidirectional in order to be able to make certain adjustments to the telegram filter. A special advantage in accordance with the underlying invention lies in the fact that by way of the trigger field 42 propagated by a further send unit 40 by means of a modulation on a higher layer, information can also be transmitted. In this process, stages are defined in the field of a transferred record, which correspond to the specific minimum receive levels and thereby indirectly determined distances between the pouch 20 and the further send unit 40 on 6.78 MHz. A length of 3 bits is for example sufficient in order to specify 8 different stages for this; without taking the safeguard bits into account. Minimum receive level means that only when it is exceeded are further units of the pouch switched to an active state. In this process, processor module 271 can preferably adjust the corresponding stage for a pouch 20 and fixed for a pouch by said processor module 271. As an alternative it is also possible that the adjustment is made dynamically. That is, the further send unit 40 determines the level and thereby the distance, within which a pouch 20 is to be switched to an active state. In order to implement the step-by-step activation, the patent specification WO 03/017207 is hereby incorporated by reference.

Wired interfaces 274, such as RS232 or USB for example, are also available for configuration of pouch 20. Likewise, control elements and a display 272 can be arranged on the pouch. For the sake of completeness, a power source 273 is also shown in FIG. 5.

The above-mentioned configuration of the pouch via the wired interface 274 can include the actions given in the following non-definitive list:
Specifying the authorized operating modes, such as for example with or without an inserted card 1;
Individualizing, for example by assigning an area 1 tag or a company-specific tag to the card;
Storage of keys for the cryptology, can be dispensed with in the case of a PKI infrastructure;
Personalizing, including by means of a PIN (Personal Identification Number) and a PUK (Personal Unblocking Key);
Defining the context of the operating elements;
Fixed reference texts for the indication on the display;
Software update for the controller 271.

In principle it is possible to initiate bidirectional communication 25 at the higher frequency—here 868 MHZ—by way of a control action using at least one operating element arranged on the pouch 20 or by insertion of the card 1. This initiation is designed to take the place of triggering by an electromagnetic near field. The disadvantages compared to the proposed solution is that, especially in the case of a plurality of persons close together, said bi-directional communication 25 is generally initiated too early and as a result problems with collisions and possibly even the ranges can occur.

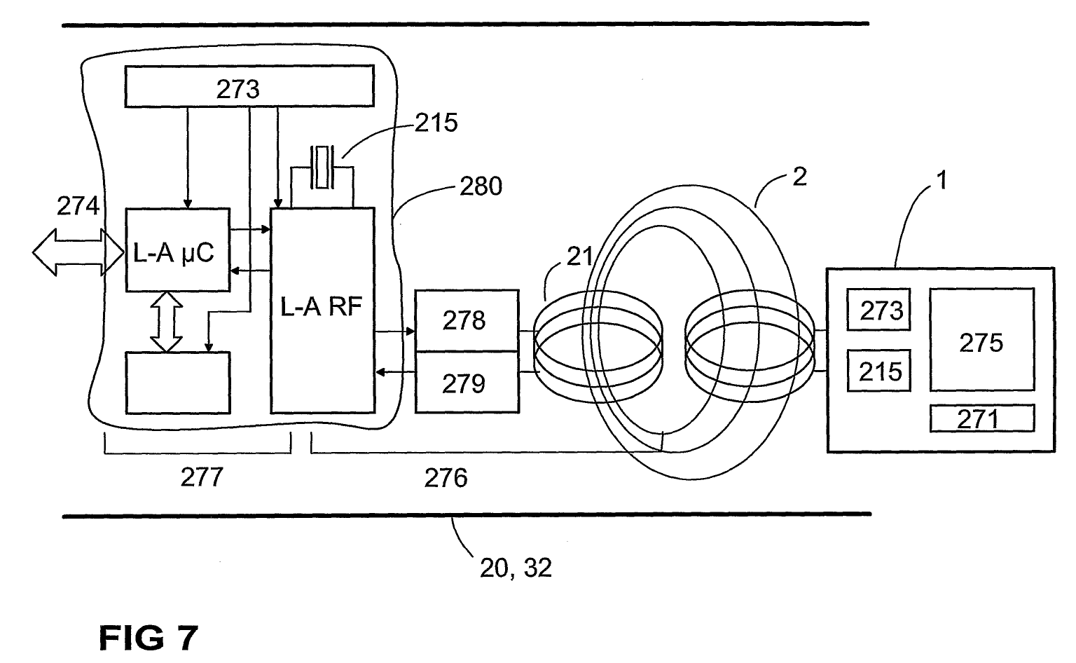

FIG. 7 shows the coupling-in of a smart card 1 to an electronic pouch 20 with a chipset from the manufacturer LEGIC. The use of standardized and commercially-available chipsets can only be advantageous in itself. The coupling-in is divided up into a digital part 277 and into an analog part 276. In addition, provision has been made for a transmitter 278 and a receiver 279 in the analog part 276. This standard solution is disadvantageous since these chipsets and their connection to an antenna 21 are designed for transmission distances in the order of magnitude from 5 to approximately 20 cm. As a result, in the case of such an implementation, too high and unnecessary power consumption is specified in the order of magnitude of a power consumption of approximately 2 W. This unnecessarily limits the autonomy of the proposed pouch.

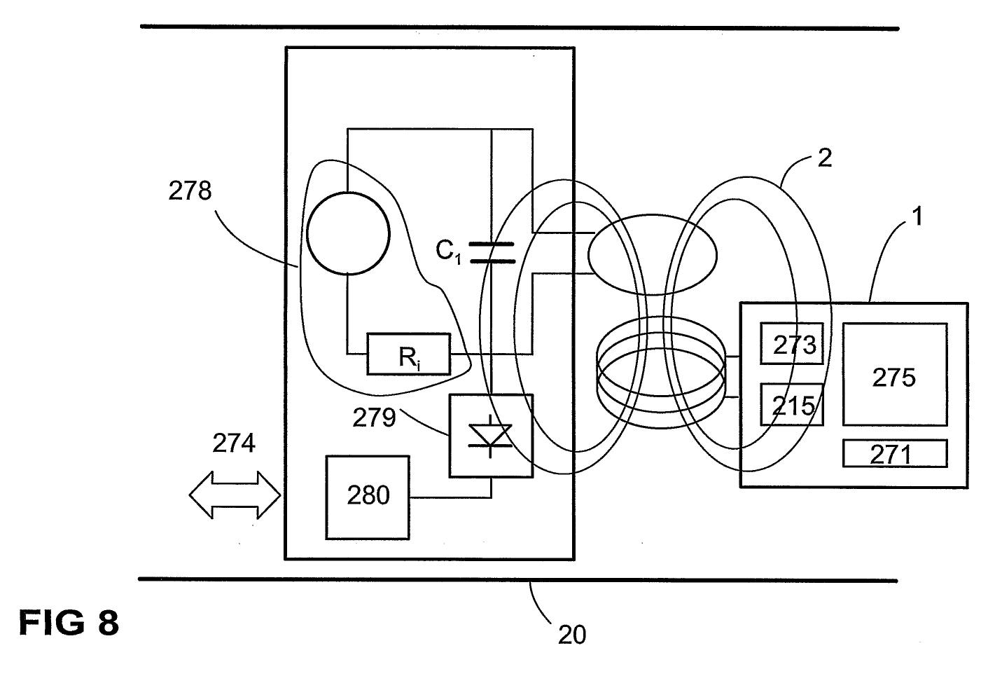

This disadvantage is rectified by means of a circuit as depicted in FIG. 8. As mentioned above, the direct spatial proximity authorizes a coupling factor of K≈1 in the card 1 inserted into the pouch 20 for a radio link 2. This allows the circuit shown in FIG. 8 with a power consumption of the order of magnitude of 10 mW. The transmitter 278 with the mentioned output of approximately 10 mW is embodied as a signal generator with an internal resistance Ri. The receiver 279 can be configured as a rectifier. The decoder 280—associated with the digital part 277, only depicted in general terms in FIG. 8—is embodied in the same way as that of the standard circuit in accordance with FIG. 7.

In addition, the mode of operation in accordance with the wiring of FIG. 8 and the theoretical background thereto are as follows:

An inductively coupled transponder consists of an electronic data carrier, usually an individual microchip, as well as a large-surface coil, which serves as the antenna. Inductively coupled transponders are operated in an almost exclusively passive manner. This means that all the power needed for the operation of the microchips must be made available by the reading device. To this end, a high frequency, electromagnetic field is produced by the antenna coil of the reading device which penetrates the cross section of the coil surface and the area around the coil. Because the wavelength of the frequency ranges used (13.56 MHz: 22.1 m) is greater by a multiple than the distance between the reader antenna and the transponder, the electromagnetic field at a distance from the transponder to the antenna may from a mathematical point of view still be treated as a simple magnetic alternating field. The largest part of the sent field penetrates the antenna coil of the transponder, which is located in the immediate vicinity of the coil of the reading device. As a result, by induction at the antenna coil of the transponder, a voltage Ui is produced. Said voltage is rectified and serves the power supply of the data carrier (microchip). A condenser C1 is switched in parallel with the antenna coil of the reading device, the capacity of which is selected in such a way that together with the coil inductance of the antenna coil, a parallel resonant circuit is formed, the resonant frequency of which corresponds to the send frequency of the reading device. The antenna coil of the transponder likewise forms a resonant circuit together with the condenser C1, said resonant circuit being matched to the send frequency of the reading device. The arrangement of the two coils can be regarded as a transformer, with a very good coupling existing between the two coils, since the distance is very small. For this reason, a very good efficiency of the power transmission between the antenna coil of the reading device and the transponder is achieved. The necessary voltage U achieved at the transponder coil is adjusted by means of the relationship of the number of turns.

The embodiments of the invention described here allow the device to be used in a number of ways, for example also for so-called crowd management, where controlling the channeling of larger streams of people through a transit zone 50 is involved. The people to be channeled through the transit zone 50 carry a pouch 20 with a card 1 identifying the relevant person. As a result of this, it is possible to identify those persons such as for example hooligans, to whom access is to be refused for security reasons. With such an embodiment of the invention it is also possible to identify by means of a camera those persons not carrying a pouch 20 or not carrying a card 1 inserted into a pouch 20.

Using the above-mentioned example of crowd management, a summary of the advantages of the invention can again be listed below:
(adjustable) short range activation 42 up to approximately 3-5 m;
bidirectional communication 25 across a larger distance in the order of magnitude of up to approximately 50 m,
because of the relatively high throughput of bidirectional communication 25, far more functions can be implemented between pouch 20 and the access unit 30 than that of the direct transmission between card 1 and a conventional card reader and as a result of this, security in accordance with the PKI method can for example be implemented. Likewise, anti-collision algorithms can be implemented with bidirectional communication 25, which deals with collisions arising from the pouch 20 such as for example that in the pouch before sending a message it is detected as to whether the medium is free and to this end reference is made to document WO 01/84472 A1, which is hereby incorporated by reference.

The functions of a card reader connected to classical technology can be distributed freely by the underlying disclosed embodiment of the invention over the pouch 20 and the access unit 60 and in this way allow a very flexible adaptation to the most diverse applications.

The current cards in accordance with ISO/IEC 14443 and ISO/IEC 15693 do not have a contact interface. However, embodiments of the underlying invention with the pouch are also possible, in the case of which the power supply/activation of the card 1 is affected in place of an electromagnetic field—radiated over the loop antenna 213—by means of a galvanic contact interface. In this process, the transmission of the card-resident tag still takes place in accordance with the relevant standards ISO/IEC 14443 and ISO/IEC 15693.

With individual card systems it is specified that only previously registered cards can be “read”. In a further embodiment of the underlying invention in accordance with FIG. 2, provision can be made for the fact that by means of bi-directional communication 25, a tag not yet registered is transmitted to the access unit 30 and is supplied to the management system 60 bypassing the card emulation and from there back to the card reader 32 in the access unit 30. Such a registration has to comply with the requirements of the specific application.

Another further embodiment of the method as claimed in the invention is described below. It has been specified above that the pouch 20 can be equipped with a display 272 and with operating elements. With bidirectional communication at the higher frequency, for example, at 868 MHz, in one of the zones assigned to the transit zone 50, information can be transmitted explicitly to the pouches 20, since their access and thus their presence are determined in this zone by the underlying invention. In this way, an emergency call and information about persons can be initiated i.e. persons carrying such a pouch on themselves. The persons registered in such a way as belonging to a zone can provide the quickest assistance on site. The information sent to these persons for example contains the name of that person who activated the emergency call and information about the current location of this person. The emergency call can be activated by means of the card pouch by pressing an operating element or a central activation at the management system 60 is also possible. In order for such an emergency call to be perceived by the relevant person, the pouch 20 in addition to the display element 272 can be extended by an acoustic and/or tactile (for example, by vibration) display element.

The information which can be shown on the display element 272 and which can be transmitted in a message on the pouch 20 can contain for example:
Coordinates, building section, room, because the whereabouts of the pouch 20 is known, depending on the granularity, i.e. how granular the method in accordance with the invention is implemented on an area;
the activating person, in this process reference can be made to the data on the smart card;
depending on the interaction of the kind of person activating the emergency call and/or the urgency of the emergency call.

With this extension of the procedure for the pouch 20 and the card 1 contained therein and coupled to said pouch, the application of expensive and additional equipment can be avoided. Such additional equipment and auxiliary services are for example a pager or a mobile telephone which can be incorporated into a so-called Corporate Mobile Network CMN. The solution presented here functions within the normal access control system and by means of the normal chip card 1 hereinafter also referred to as the employee badge.

In this specification, reference was in some cases made to the Legic card system. However, the invention can also be implemented with other card systems such as, for example, the Mifare card system and in particular as shown in FIG. 8 with substantial simplifications, if the standard chip sets that have been provided are dispensed with.

1.-22. (canceled)

23. In a system for providing access to a predetermined zone and including a portable pouch having an inserted electronic card, a card receive module and a send/receive module coupled to the card receive module, wherein the electronic card includes at least one tag, and wherein the tag is transmitted in a wireless manner from the card to the card receive module, and an access unit assigned to a transit region of the zone and having a send/receive unit configured for a communication with the send/receive module of the pouch, a method for providing access to the predetermined zone, comprising:
transmitting the tag to the send/receive unit of the access unit when the pouch is within a predetermined range of the first send/receive unit;
determining by the access unit if the tag received by the send/receive unit matches a stored tag;
generating an unblocking signal for providing access to the zone if the received tag and the stored tag match;
detecting with a signal detector of the pouch an electromagnetic field generated by a send unit arranged in the transit region;
processing information transmitted by means of the electromagnetic field, wherein the information defines a predetermined minimum receive level necessary for activating electronic components of the pouch; and
initiating a bidirectional communication between the send/receive unit of the access unit and the send/receive module of the pouch.

24. The method of claim 23, further comprising activating the electronic components of the pouch in a step-by-step manner depending on further information transmitted during the bidirectional communication.

25. The method of claim 23, wherein a loop antenna is arranged in the pouch, the loop antenna being provided for receiving the electromagnetic field from the send unit and for transmitting the tag from the card to the card receive module.

26. The method of claim 23, further comprising, by means of the bidirectional communication, transmitting a tag of the pouch to the send/receive unit of the access unit, wherein the tag of the pouch and a further stored tag are used for the generation of the unblocking signal.

27. The method of claim 23, wherein the send/receive unit of the access unit is connected to a card load modulation unit in the access unit, which emulates the card located in the pouch, so that in the access unit a card reader corresponding to the card is subsequently connected to a computer system for the generation of the unblocking signal.

28. The method of claim 23, wherein the send/receive unit of the access unit is connected by wire to a card reader corresponding to the card for connection to a computer system for the generation of the unblocking signal.

29. The method of claim 23, further comprising terminating wireless transmission from the card to the card receive module in the pouch, and transmitting by means of the bidirectional communication encryption information in accordance with a PKI method.

30. The method of claim 27, further comprising transmitting, by means of the bidirectional communication, a message from the send/receive unit of the access unit to the send/receive module of the pouch, and displaying the message on a display element of the pouch.

31. The method of claim 30, wherein the message is sent from the send/receive unit of the access unit based on at least one of:
an activation of an operating element located on a further pouch, and
an interaction of the computer system.

32. An electronic portable pouch, comprising:
a support for attaching a card storing a tag;
a card receive module located on the pouch, wherein the card receive module is configured to receive the tag in a wireless manner when the card s attached;
a send/receive module connected to the card receive module and configured to provide for a bidirectional communication with an access unit for providing access to a zone; and
a signal detector configured to detect an electromagnetic field and to activate the send/receive module for bidirectional communication with the access unit, wherein a common loop antenna is provided for receiving the electromagnetic field and for wireless transmission of the tag from the card to the card receive module.

33. The pouch of claim 32, further comprising at least one wired interface for configuring data to be transmitted to the pouch.

34. The pouch of claim 32, wherein the tag is personified, and wherein the personified tag is transmitted from the send/receive module to the access unit.

35. The pouch of claim 32, wherein a further tag is assigned to the pouch, and wherein the further tag is transmitted to the access unit via the send/receive module.

36. The pouch of claim 32, further comprising a display element configured to display at least one of operating modes, detection data, transactions and references.

37. The pouch of claim 32, wherein at least one operating element is arranged on the pouch, and wherein the operating element is configured to allow one of setting an operating mode and activating user interaction for access to a user interaction zone.

38. The pouch of claim 32, further comprising at least one of an acoustic and a tactile display element.

39. The pouch of claim 38, further comprising at least one operating element configured to control a display content of the display element.

40. The pouch of claim 32, further comprising a telegram filter configured analyze transmitted information in order to activate further electronic components of the pouch subject to the received information in a step-by-step manner.

41. The pouch of claim 32, further comprising an encryption unit configured to operate in accordance with a PKI method.

42. An access unit for providing access to a zone with an electronic card containing at least one personified tag, comprising:
a send/receive unit for communication with an electronic pouch containing a card in order that a personified tag is transmitted from the pouch to the send/receive unit;
a card reader;
and a card load modulation unit connected to the send/receive unit, wherein the tag is transmitted by means of a card emulation.
